(19) United States
(12) Patent Application Publication
(10) Pub. No.: US 2019/0220104 A1
(43) Pub. Date: Jul. 18, 2019

(54) METHOD AND APPARATUS FOR VEHICULAR MOBILE OFFICE SERVICES

(71) Applicant: FORD GLOBAL TECHNOLOGIES, LLC, Dearborn, MI (US)

(72) Inventor: Brandon Ryan Buckhalt, Canton, MI (US)

(21) Appl. No.: 15/869,308

(22) Filed: Jan. 12, 2018

(51) Int. Cl. G06F 3/038; G07C 5/02; G06F 13/40; G06F 3/14; G06F 3/02; G06F 3/0354

(52) U.S. Cl. CPC G06F 3/038; G07C 5/02; G06F 13/4081; H04M 1/72519; G06F 3/0219; G06F 3/03543; G06F 3/1423

(57) ABSTRACT

A system includes a processor configured to detect a presence of a docked phone and responsively determine whether a vehicle is in a predetermined safe-state for mobile office functionality. The processor is also configured to engage desktop functionality on a vehicle display, responsive to determining that the vehicle is in the safe-state. The processor is additionally configured to engage an application to translate keyboard and mouse controls into phone controls and enable a wireless keyboard and a mouse for control of the vehicle display.

### TECHNICAL FIELD

The illustrative embodiments generally relate to methods and apparatuses for vehicular mobile office services.

### BACKGROUND

With mobile devices providing increased connectivity and application services, it is common for on-the-go people to process emails and other limited work functions from a cellular phone. Of course, most phones have limited screens and limited keyboards, which generally tend to make typing a long response or editing a document a painful task.

Vehicles, especially electric vehicles, are increasingly equipped with large center display screens, which often closely resemble computer monitors. Of course, the vehicle lacks the typical keyboard and mouse functionality of a desktop or laptop computer, and the screens instead tend to be touch-sensitive, making them only slightly more suitable for typing than a phone display.

### SUMMARY

In a first illustrative embodiment, a system includes a processor configured to detect a presence of a docked phone and responsively determine whether a vehicle is in a predetermined safe-state for mobile office functionality. The processor is also configured to engage desktop functionality on a vehicle display, responsive to determining that the vehicle is in the safe-state. The processor is additionally configured to engage an application to translate keyboard and mouse controls into phone controls and enable a wireless keyboard and a mouse for control of the vehicle display.

In a second illustrative embodiment, a system includes a processor configured to detect a presence of a docked phone in a vehicle docking bay. The processor is further configured to engage desktop functionality on a display associated with the docking bay, responsive to detecting the phone. The processor is also configured to enable a keyboard and mouse for control of the phone and route commands from the keyboard and mouse to the display associated with the docking bay.

In a third illustrative embodiment, a system includes a processor configured to repurpose a vehicle control, provided with a primary function other than cursor control, as a display cursor control, responsive to determining that a desktop functionality has been enabled on a vehicle display. The processor is also configured to route commands from the repurposed control to the vehicle display to control a cursor displayed on the display.

### BRIEF DESCRIPTION OF THE DRAWINGS

FIG. 1 shows an illustrative vehicle computing system;

FIG. 2 shows an illustrative process for vehicle-to-phone mirroring and manipulation;

FIG. 3 shows an illustrative process for dynamic screen allocation and control; and

FIG. 4 shows an illustrative process for vehicle control configuration.

### DETAILED DESCRIPTION

As required, detailed embodiments are disclosed herein; however, it is to be understood that the disclosed embodiments are merely illustrative and may be incorporated in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the claimed subject matter.

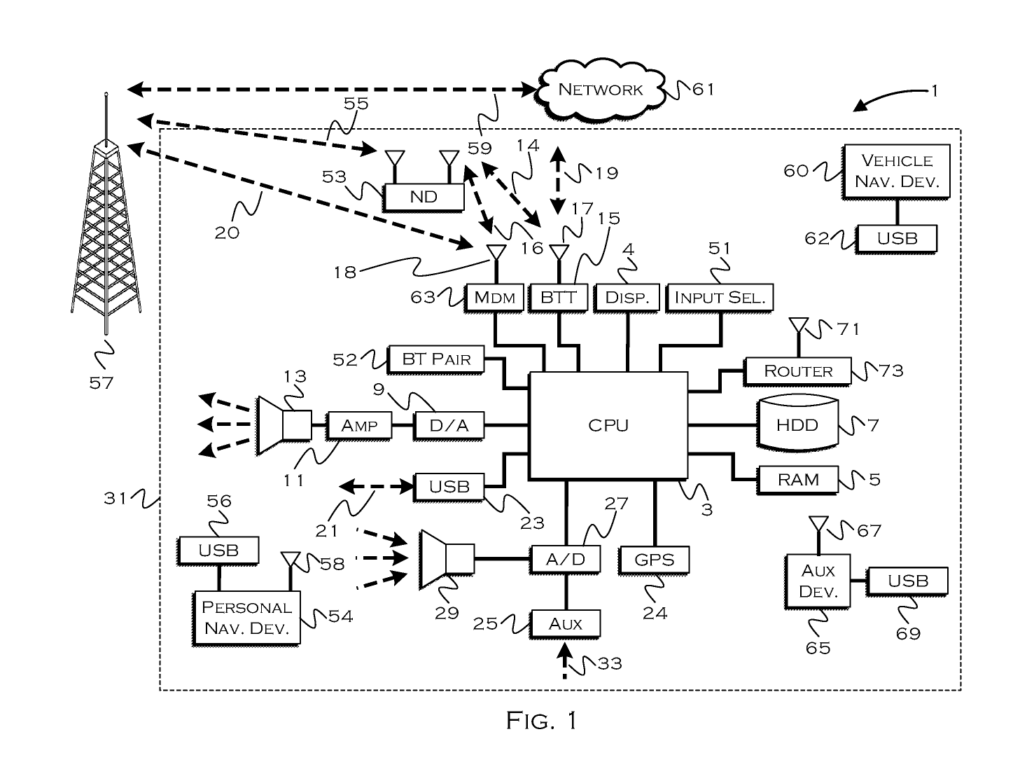

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touchscreen display. In another illustrative embodiment, the interaction occurs through button presses, spoken dialog system with automatic speech recognition, and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be transmitted to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device (hereafter referred to as ND) 53 can then be used to communicate 59 with a network 61 outside the vehicle 31 through, for example, communication 55 with a cellular tower 57. In some embodiments, tower 57 may be a Wi-Fi access point.

Exemplary communication between the ND 53 and the BLUETOOTH transceiver 15 is represented by signal 14.

Pairing the ND 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with ND 53. Alternatively, it may be desirable to include an onboard modem 63 having antenna 18 in order to communicate 16 data between CPU 3 and network 61 over the voice band. The ND 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, the ND 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. If the user has a data-plan associated with the nomadic device, it is possible that the data-plan allows for broadband transmission and the system could use a much wider bandwidth (speeding up data transfer). In yet another embodiment, the ND 53 is replaced with a cellular communication device (not shown) that is installed to vehicle 31. In still another embodiment, the ND 53 may be a wireless local area network (LAN) device capable of communication over, for example (and without limitation), an 802.11g network (i.e., Wi-Fi) or a Wi-Max network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a Wi-Fi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Automotive original equipment manufacturers (OEMs) are moving towards larger and larger screens in a front center position in vehicles, which provide bigger display of more control options. Of course, since these screens are viewable by a driver, it is typically inadvisable to use the display for many common media functions, such as viewing a movie.

On the other hand, when a vehicle is parked, it may be completely appropriate to allow unfettered use of the large display, to do a variety of functions. While media functions typically require limited control, using the screen to respond in a complex manner to emails, or to edit documents, may still be difficult because of the common touch-interface.

The illustrative embodiments propose coupling a screen to a smart phone to mimic an office desktop. By using a smartphone as a portable computing entity, the memory and processor can easily be moved between an office and a vehicle. By providing a stowable keyboard and/or mouse, the user can experience a more typical screen interface

The phone can be docked in a vehicle-provided docking station, which can be integrated or USB connected to a vehicle computing system. The vehicle can use the phone connection to mirror a phone display and run an application to provide mouse/keyboard control over phone applications. In other examples, the vehicle can use a remote connection to connect to a server holding the office functionality, through which applications can be accessed and data can be transferred.

Once the vehicle has begun to function as a mobile office, the user can act as though the screen represented a typical office computer monitor, answering emails, editing documents, surfing the internet and utilizing other office functionality. Because there may not be a convenient location on which to utilize a mouse, the vehicle could alternatively repurpose a vehicle control to serve as a mouse when appropriate.

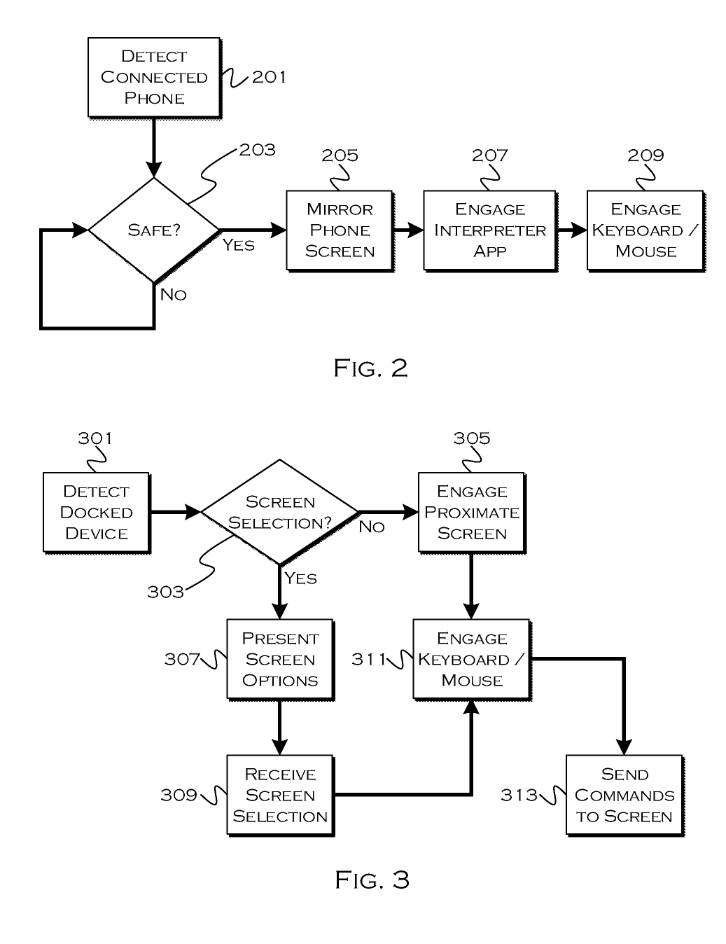

FIG. 2 shows an illustrative process for vehicle-to-phone mirroring and manipulation. In this illustrative example, the process begins to function when phone is docked within a vehicle docking station. In other examples, if the docking station is also used for charging, a secondary instruction may be used to engage the office functionality.

Here, the process detects 201 the docked phone and determines 203 if it is safe for a user to engage office functionality. Many vehicle screen control features are disabled while a vehicle is in use, at least on a driver-accessible screen, and typically if a vehicle is at rest these features can be accessed. Since typing on a keyboard is typically much more attention-controlling of a process than interacting with a screen, in this example the process actually determines whether the vehicle is parked. In other examples, the process could require the engine to be powered down (but the vehicle accessory power would still be provided), and if desired the process could be no more limiting than more traditional lock-out (access provided at low speed or when stopped).

Once the process determines that the vehicle is in a safe condition, the vehicle can begin to mirror 205 the phone display, so that the user can interact with the phone through a vehicle display. In other examples (such as when the connection is with a central application server), the process could launch a desktop display, so the user knows that desktop functionality is now enabled.

If the vehicle will permit use of a keyboard and/or a mouse to interact with the phone, the process may also launch 207 an application usable to translate keyboard/mouse commands into suitable screen controls. Since phones typically do not include cursors, for example, the interpreter program may provide cursor functionality and optimize other control features to best control the phone via a keyboard/mouse.

Finally, the process enables 209 a keyboard and mouse. The keyboard and mouse may be stowable in a vehicle compartment, and in some examples the mouse may be a repurposed vehicle control. Controls which have 2-axis functionality are most useful for this repurposing, which can include mirror controls and some steering wheel controls often used to scroll in vehicle menus, but not commonly used for cursor control.

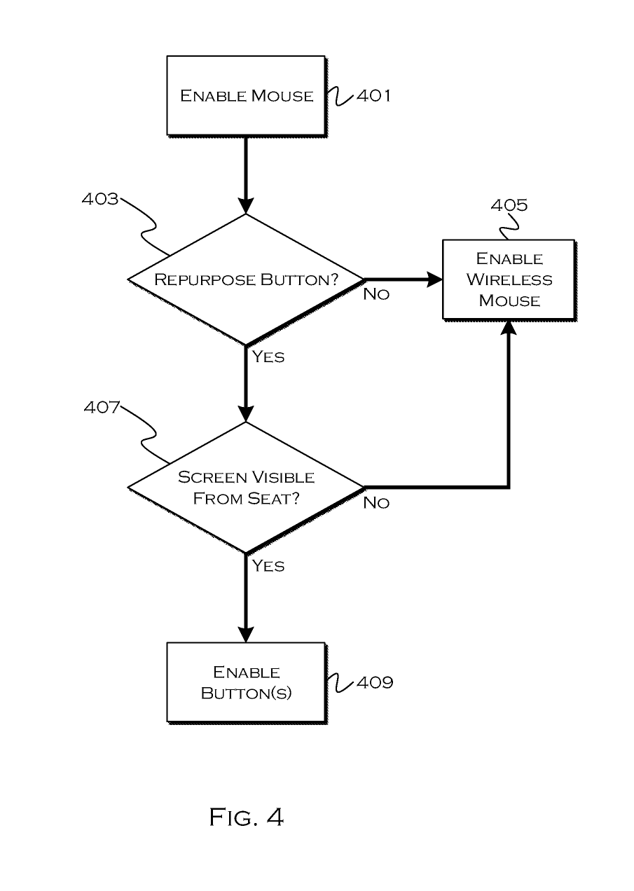

FIG. 3 shows an illustrative process for dynamic screen allocation and control. In this example, the process detects 301 a docked device, which can be docked in one of a plurality of possible docking points, in this example. That is, there may be a docking point corresponding to each seat, each screen or, for example, two points (driver/passenger) for the primary screen and a point for each rear screen. Any reasonable configuration of docking points is possible, and a single docking point may also be assignable to a particular screen (via a docking point control or an on-screen control).

If a docking point is assignable 303 to a particular screen, the process may present 307 options corresponding to various selectable screens, responsive to detecting the docked device. In other scenarios, the docking bay may include buttons or a dial for selecting from multiple screens. Once the process receives 309 selection of a particular screen, the process may then enable 309 a keyboard and mouse. Enablement may also be responsive to a safety check, as previously described, especially if the selected screen is a driver screen.

In the example described, there are three vehicle screens, a central screen, and two rear displays. If the docking point is assigned to a rear display, the process may forego the safety check since the driver cannot utilize the rear display. If the docking point is assigned to the front display, then in one example the safety check may be required. In another example, the process may allow the front display to function, but mouse control may be provided via a passenger-side control (e.g., mirror control), to minimize driver control of the screen.

In a similar example with the same screen configuration, the process may include docking stations corresponding to each seat in the vehicle. In this example, there may not be an explicit selection of a screen, since each docking station corresponds to a particular screen. In this model, the process routes 305 communication between the device and a corresponding proximate screen (proximate to the docking station).

Responsive to a screen being assigned, the process may engage 311 a keyboard and/or mouse. As previously noted, the mouse can be a typical mouse or a repurposed vehicle control, commonly used for something else. Finally, the process sends 313 commands from the keyboard/mouse to the screen selected for device interaction.

FIG. 4 shows an illustrative process for vehicle control configuration. This example demonstrates how a vehicle control can be repurposed as a mouse control. This process can occur when a primary process for desktop control seeks to provide 401 a mouse. If the process is instructed 403 to repurpose a control, the process may either present a list of options for controls to repurpose or enable 409 a control such as a driver mirror or steering wheel control. In this example, the process also determines 407 if the screen designated for control is viewable from a driver seat. That is, the rear screens are not viewable by a driver, so it is unlikely that a screen providing a rear seat desktop should be controlled by a driver mouse control. In those cases, or if explicitly requested, or if a standard mouse is simply detected, in some instances, the process may enable 405 a standard wireless mouse.

The wireless mouse will commonly be used for rear display mouse control, since the rear seats typically lack two axis control knobs that are convenient for passenger manipulation. If such a knob is present, however, it may be repurposed to function as a mouse control.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined in logical manners to produce situationally suitable variations of embodiments described herein.

1. A system comprising:
a processor configured to:
detect a presence of a docked phone and responsively determine whether a vehicle is in a predetermined safe-state for mobile office functionality; and
responsive to determining that the vehicle is in the safe-state:
engage desktop functionality on a vehicle display;
engage an application to translate keyboard and mouse inputs into the vehicle into phone controls to be sent to the phone from the vehicle; and
enable a wireless keyboard and a mouse for control of the vehicle display.

2. The system of claim 1, wherein the safe-state includes the vehicle being in park.

3. The system of claim 1, wherein the safe-state includes the vehicle being stopped or traveling at a predetermined minimum speed.

4. The system of claim 1, wherein the safe-state includes the vehicle engine being powered down.

5. The system of claim 1, wherein engaging the desktop functionality includes mirroring a phone display.

6. The system of claim 1, wherein engaging the desktop functionality includes launching a predefined desktop display.

7. The system of claim 1, wherein the processor is configured to repurpose a vehicle control designated for a primary purpose other than mouse control to function as a mouse control.

8. The system of claim 7, wherein the control includes a vehicle mirror control.

9. The system of claim 7, wherein the control includes a steering wheel radio and vehicle computing system control, which does not typically function as a cursor control.

10. A system comprising:
a processor configured to:
detect a presence of a docked phone in a vehicle docking bay; and
responsive to detecting the phone:
engage desktop functionality on a vehicle display associated with the docking bay;
enable a keyboard and mouse for control of the phone; and
route command signals from the keyboard and mouse to the vehicle display associated with the docking bay.

11. The system of claim 10, wherein the vehicle display is one of a plurality of vehicle displays, the vehicle display being selectable through manipulation of a control provided to the docking bay.

12. The system of claim 10, wherein the vehicle display is one of a plurality of vehicle displays, the vehicle display being selectable through manipulation of a digital screen assignment control.

13. The system of claim 10, wherein engaging the desktop functionality includes mirroring a phone display.

14. The system of claim 10, wherein engaging the desktop functionality includes launching a predefined desktop display.

15. The system of claim 10, wherein the processor is configured to repurpose a vehicle control designated for a primary purpose other than mouse control to function as a mouse control.

16. The system of claim 15, wherein the control includes a vehicle mirror control.

17. The system of claim 15, wherein the control includes a steering wheel radio and vehicle computing system control, which does not typically function as a cursor control.

18. A system comprising:
a processor configured to:
repurpose a vehicle control, provided with a primary function other than cursor control, as a display cursor control, responsive to determining that a desktop functionality has been enabled on a vehicle display; and
route commands from the repurposed control to the vehicle display to control a cursor displayed on the display.

19. The system of claim 18, wherein the vehicle control includes a window control.

20. The system of claim 18, wherein the vehicle control includes a steering wheel menu control.
